(19) United States
(12) Patent Application Publication
(10) Pub. No.: US 2012/0084288 A1
(43) Pub. Date: Apr. 5, 2012

(54) CRIMINAL RELATIONSHIP ANALYSIS AND VISUALIZATION

(76) Inventors: MOHAMMED ABDUL-RAZZAK, Union City, CA (US); Bulent Erbilgin, Cupertino, CA (US); Cemal T. Dikmen, Trumbull, CT (US); Subhrajyoti Ray, San Jose, CA (US); Martin Tomas C. Guerrero, Santa Clara, CA (US); Tony Walter, San Jose, CA (US)

(21) Appl. No.: 13/009,795

(22) Filed: Jan. 19, 2011

Related U.S. Application Data
(60) Provisional application No. 61/388,605, filed on Dec. 22, 2010.
(60) Provisional application No. 61/389,192, filed on Oct. 1, 2010.

(51) Int. Cl. G06F 17/30

(52) U.S. Cl. 707/737; 707/E17.059

(57) ABSTRACT

Systems and methods of organizing a set of information associated with a record in a centralized database are disclosed. The record may be associated with a criminal investigation and/or a person of interest (POI). In one embodiment, the method includes creating a profile for the record and a corresponding set of data associated with the profile. The method also includes graphically clustering the set of information associated with the profile. In another embodiment, the method includes linking a data associated with a particular profile to another data associated with another profile based on a set of predetermined association factors. The method also includes generating a set of links and connections between a particular profile and a set of other profiles in the database. The method further includes visually representing the set of connections to a user of the system.

### REFERENCE TO RELATED APPLICATIONS

This application claims priority to provisional applications: Ser. No. 61/388,605 filed Sep. 30, 2010; and Ser. No. 61/389,192 filed Oct. 1, 2010, both entitled: “Multi-Tier Integrated Security System and Method To Enhance Lawful Data Interception and Resource Allocation,” which applications are also incorporated by reference herein in their entirety.

### FIELD OF TECHNOLOGY

This disclosure relates to analysis of various types of data including but not limited to cyber data, and in particular to sharing and managing a set of information and digital content obtained through legal means.

### BACKGROUND

An analyst (for example a law enforcement analyst, a financial analyst, an analyst in a fund managing company, an analyst at an IT department, a marketing analyst, a local police officer, a secret agent, a member of the CIA, etc.) may want to investigate a suspect, who may be a person of interest (POI) in a particular investigation. The analyst may need to gather a set of information associated with a POI, and may want to find links between the POI and other POIs connected to the POI. The analyst may want to look up a complete set of information collected on a particular case, and may want to find a set of leads to better investigate the case. The analyst may want to find a set of other suspects related to the case based on the complete set of information collected on the particular case. To compile the set of information, the analyst may need to research at multiple information sources to gather basic information about the POI. Even when the set of information is procured from multiple sources, the analyst may need to manually construct additional graphs and/or create other tools to visualize the set of information procured. This may be a time consuming and inefficient task. For example, a particular analyst, may want to investigate a particular POI, “A”, located in a particular city. The analyst may have to comb through multiple databases to find a set of basic information about A, like background, history, local police records, local jail records, travel history, contacts etc. During a subsequent investigation, analyst may need to again manually comb through the multiple databases to update the basic information about A. After finding the set of information, the analyst may need to employ additional visualization tools to organize, analyze and better comprehend the set of information. Needless to say, this may require a lot of time and effort for the analyst.

Furthermore, the analyst may be unable to find accomplices and/or other POIs associated with the investigation using conventional means. The analyst may also simply fail to notice certain similarities or trends associated with the particular POI, and/or the POI in comparison to a set of other POIs, and therefore may miss vital clues in the investigation. For example, absent visualization techniques, the analyst may not make a connection between A and a childhood friend of A simply because the childhood friend of A has been operating in another city. Similarly the analyst may not immediately notice a trend in A's communication pattern and may consequently miss an important lead in the investigation.

Moreover, the analyst may not be aware of a set of relevant additional details associated with the POI, and may lose valuable time finding more information about the POI, and/or neglecting to investigate a certain lead. As a result, the particular investigation may get unnecessarily delayed, and the suspect and/or POI may remain a threat to law enforcement official and the public for a longer period of time, if not, forever.

### SUMMARY

Disclosed are a method and a system of sharing and managing a set of information and digital content obtained by analysts. In one aspect the method includes organizing a data associated with a record in at least one database. The data may be at least one of a metadata and a content. The method also includes creating a profile based on the data associated with the record. The method also includes graphically clustering the data associated with the profile. The method further includes graphically linking the data with an other data of an other profile based on a set of predetermined association factors. In addition, the method also includes determining a connection between the profile and the other data.

The record may pertain to at least one of a person of interest (POI) an employee of a corporation, a criminal investigation, an event, a group of individuals, a gang, a phone number, a cyber name, a cyber address, a physical address, a website, a cyber server address, a web host, a phone record and a warrant.

The predetermined association factors may be based on at least one of a geographical commonality, a number of common terms, a number of common suspects, a physical commonality, a number of recurring names, a type of crime, a type of event, a type of cybername or cyber address, a number of common aliases, a similar type of website, a similar type of event, a number of known suspects, a common crime scheme, a common analyst, a number of common analysts, a common jurisdiction area, a number of common words in the cyber activity, a number of common words between the records, a number of common names, a number of common events, a number of common keywords, a common attribute between a POI and an other POI, a keyword, a common criminal history between two POIs, at least one common friend between two POIs, a common link between two POIs, a membership in a particular gang, a number of mutual friends between two POIs, a number of similar interests between two POIs, a commonality in victims between two POIs, the common crime scheme between two POIs, known information about the POI to the other POI, a known interaction to the other POI, a number of visits by the POI to a particular physical location, a frequency of visits by the POI to the particular physical location, a number of visits by the POI to a particular cyber location, a frequency of visits by the POI to the particular cyber location, a number of communication attempts between the POI and the other POI, a frequency of communication attempts between the POI and the other POI, a use of a specific communication device, an information about a means and methods of a communication an information about a pattern of communication, a telephony number of the POI, a cyber identifier associated with POI, a digital signature of the POI, a cyber personality of the POI, any information that distinguishes the POI from others.

Further, the method also includes authenticating a set of users to access a particular profile based on a role based access control. The method also includes tracking the particular profile based on the role based access control. The method also includes generating an alert to the set of users tracking the particular profile.

The data associated with the record may be at least one of a metadata and a content. The metadata may be at least one of an information about a location of the POI, an information about a whereabouts of the POI, a geographical location of the POI, a time and location of the POI, an information about an IP packet, an information about a type of data collected, an IP information, a cyber address, an event information, a geographical information about an event, a source and destination IP address of a cyber activity, a version, a length, a set of email options, a padding information , error correction information, identification of a sender of an a cyber communication, identification of a receiver of a cyber communication, a flag associated with a cyber communication, a protocol information, a subject line of a cyber communication, an attachment information, a routing information and a proxy server information, a telephony record, a social networking data, a buddy list, a contact list, an avatar, and address of a website.

The content may be at least one of a background of a POI, a crime profile of the POI, a racial profile of the POI, a family and friend circle of the POI, a history of criminal records of the POI, a criminal propensity of the POI, a modus operandi of the POI, and a police record data of the POI, a set of cyber communications associated with the POI, a set of internet chats associated with the POI, a set of social networking data associated with the POI, a content of telephony calls associated with the POI, a set of networking data associated with the POI, a chronological data associated with an event, a geographical data associated with the event, an identity of individuals associated with the event, a police tracking data associated with the event, a newspaper coverage of the event, a set of general information known about the event, a contact information associated with a group of individuals, an association between the group of individuals, a set of known information about the group of individuals, a known information about a gang, a latest update about the gang, the identity of individuals belonging to the gang, a set of data associated with a phone number, a set of data associated with a cyber communication, a set of data associated with a physical address, a set of data associated with the geographical location, a set of data associated with a web host, a set of data associated with a phone record, a set of data associated with a warrant.

The method may further include organizing and displaying the data based on a set of user-defined preferences. The set of user-defined preferences may be at least one of a display options, profile-security options, profile-display options and association management options.

The method further includes graphically representing the data associated with the profile. The method also includes creating a graphical timeline of the data associated with the profile.

The method includes synthesizing a category of information in the profile with the same category of information in the other profile. The method also includes measuring a degree of similarity in the category of information in the profile with the other profile. The degree of similarity may be based on a number and a frequency of predetermined association factors that are applicable between the profile and the other profile. The method may also include graphically representing the connection between the profile and the other profile within the category of interest. The method also includes highlighting the connection when the degree of similarity is higher than a predetermined threshold value. The predetermined threshold value may be based on at least one of a weight given to a particular predetermined association factor, a number of matching predetermined association factors and a user-determined predetermined association factor. The method may also include generating an alert to at least one of a creator and a tracker of the profile when the degree of similarity is higher than the predetermined threshold value.

The method may also include graphically comparing the data of the profile with a corresponding data of a chosen profile. The method also includes generating a set of possible links based on the set of predetermined association factors between the profile and the chosen profile. The method also includes generating a set of possible links based on the set of predetermined associated factors between the profile and an existing data in the database. The method also includes generating a degree of separation factor based on the connections between the profile and the chosen profile. The method further includes eliminating a particular possible link based on a response of a creator of the profile. In addition, the method also includes highlighting the particular possible link based on the response of the creator of the profile.

The method also further includes providing a lead based on the data associated with a particular profile. The method may also include generating a link to find a potential target based on the lead. Further, the method may include generating the lead and other leads based on the particular search.

The method may also include maintaining an audit record of a set of changes made by a particular user. The set of changes made by the particular user may pertain to at least one of an edit, an entry, a deletion, an uploaded material, privacy options and security options. The method may also include automatically saving the set of changes in the audit record. The method further includes generating the audit record when requested by an authorized auditing personnel.

The method may further include displaying at least a portion of a particular profile in response to a search performed by a new user. The method may also include determining a relevance between the profile and a search based on a relevance algorithm. The relevance algorithm may be based on at least one of a similarity of name, a similarity of characteristic, a similarity of crime type, a known gang, a known criminal propensity, a similarity of geographical location, a similarity of background, a similar criminal history, a similar motive, a number and frequency of recurring keywords, a number of visits to a particular physical location, a frequency of visits to a particular physical location, a number of visits to a particular cyber location and a frequency of visits to a particular cyber location. The method may also include authenticating the new user to access a larger view of the entire profile based on a role based access control. The method may also include authenticating the new user to update the particular profile based on the role based access control.

The method may further include automatically matching the profile with a similar profile based on the predetermined association factors and a data associated with the similar profile. The method may also include graphically generating a set of possible links between the profile and the similar profile.

The method may also include retrieving a relevant set of data in response to the search when no profile is available. The method further includes displaying the relevant set of data based on the relevance algorithm. The method may also include permitting the new user to create a new profile for the relevant set of data. The method may include determining a set of security controls to access the profile associated with the record. The method may also include performing a task on the profile based on a role based access control. The task may be at least one an input of a new data to the profile, a creation of the profile, a reading of the profile, a deletion of the profile and a deletion of a part of the profile. The method may also include authenticating a user to perform a task on the profile based on a role based access control. The method further includes performing a metaheuristic analysis of the new information against an existing data in the database. The method may further include determining an accuracy of the update of the profile based on a set of accuracy factors. The set of accuracy factors may be at least one a consistency of data, a conflicting data, and a prior matching pattern of data. The method also includes automatically updating the new data on the profile based on a role based access control. The method may also include generating an alert when the profile is updated.

The predetermined screen criteria may be at least one of a system-controlled minimum security criteria and a user-controlled minimum security criteria.

The method may also include broadcasting an update to a given profile through at least one of an update page associated with an account of a particular user, a compilation cyber communication, a text alert and a cyber alert. The method also includes tagging the update of the given profile with the source of the update through a tagging means. The tagging means may be at least one of a color-coded tag, a user-coded tag and a comment box. The method may also include compiling a set of updates into a statistical review to account for an accuracy of the user's individual historical activity. The method may also include graphically representing the statistical review associated with the user.

The method further includes linking a set of other profiles to an individual profile. The individual profile may be at least one of an investigation, a gang, a location, an event and a group of individuals. The method may also include determining a set of qualifying criteria to link a qualifying profile to the individual profile. The method also includes matching the qualifying profile to the individual profile based on the qualifying criteria and the predetermined association factors. The method may also include consolidating the set of information of an qualifying profiles to create a group data. The method further includes graphically clustering the group data. The method may also include a set of connections between the qualifying profiles based on the predetermined association factors.

The method may also include verifying that only one profile exists for a particular POI. The method also includes automatically notifying the user when the profile already exists for the particular POI.

The method may also include uploading a data associated with the POI to the profile. The data may be at least one of a picture, a background, a CV, a criminal record, a warrant, a conviction, a network of known and possible friends, a crime type, a criminal history, a set of cyber names, a set of cyber addresses, a set of telephony addresses, a set of known location and a set of electronic and cyber communication data obtained legally. The method further includes graphically displaying related profiles by clustering the data of the profile with other profiles. The method also includes modifying a graphical display based on a response of a creator of the profile.

The data may be acquired from at least one of a lawfully-acquired data from a lawful database, a lawful data interception, a lawful interrogation, a lawful police record, general public information, a keyword, a media record, an information obtained from a website, information associated with an IP address, a phone record, a private record, a public record and a police record.

In another aspect, the method may include evaluating a profile associated with a record against at least one other profile associated with an other record. The method may further include determining a degree of similarity between the profile and the other profile based on a set of predetermined association factors. The method may also include automatically creating a connection between the profile with the second profile when the degree of similarity is greater than a predetermined threshold value. The method further includes analyzing a set of connections between the profile and the other profile. The method may further include graphically displaying the set of connections between the profile and the other profile.

The record may pertain to at least one of a person of interest (POI), a criminal investigation, an event, a group of individuals, a gang, a phone number, a cyber address, a physical address, a website, a phone record and a warrant.

The other profile may be selected through at least one of a direct selection by a user and a result of a query entered by the user.

The query entered by the user may be at least one of a query based on name, a query based on an event, a query based on a gang, a query based on a geographical location, a query based on a background, a query based on a biographical information, a query based on a history, a query based on a criminal record, a query based on a set of current events, a query based on recent updates, a query based on a type of weapon, a query based on a particular gang, a query based on a type of crime, a query based on a type of motive and a query based on a cyber activity between a POI and a set of other POIs, a pattern or frequency of communication activity, a set of phone numbers, a cyber name, a cyber address, and a device address, a VOIP address, a web forum login, a website login, a chat alias, a social network login.

The method may further include graphically mapping the connection between the profile and other profiles based on a set of graphic-mapping options. The set of graphic-mapping options may be at least one of a default graphic-mapping option, a user-defined graphic-mapping option, a timeline of activity, a degree of separation between the profile and other profiles, a geographical representation of a set of profiles, a communication link between the profile and other profiles, a historical representation of a profile, a law enforcement timeline of a profile, common records of interest in the profile with the other profile and a user-defined matching factor between the profile and the other profile.

The method may also include generating a graphical connection between a set of profiles based on a particular query entered by the user. The method may also include modifying the graphical connection based on a response of the user. The method may also include eliminating a particular geographical connection based on the response of the user. The method also includes highlighting the particular graphical connection based on the response of the user.

The method may also include identifying a shortest connection between the profile and other profile. The method may also include identifying a shortest connection between a POI an other POI. When at least two equal shortest connections are identified between the profile and the other profile, the method may also include assigning a weight to a most relevant connection. When at least two equal shortest connections are identified between the POI and the other POI, the method may also include assigning a weight to a most relevant connection. The weight may be determined through at least one of a user selected criteria, a system criteria and a degree of similarity between the profile and the other profile. The method also includes graphically highlighting the shortest connection.

In yet another aspect, a system comprising a volatile memory and a non-volatile storage further includes a profile to store a data associated with a record. The record may pertain to at least one of a person of interest (POI), a criminal investigation, an event, a group of individuals, a gang, a phone number, a cyber name, a cyber address, address, a physical address, a device address, a web host, a web site login, a web forum login, a chat alias, a VOIP address, a phone record and a warrant. The system further includes a database to house the profile and other profiles. The system also includes a graphical user interface (GUI) to display the data. The system also includes an analysis module to synthesize the data associated with the record and a set of other records, to organize the data associated with the record and the set of other records, to determine a connection between the profile and the set of other profiles based on a set of predetermined association factors, to filter the data when a query is entered, to graphically cluster the data associated with the profile and to graphically link the data of the profile with another data.

The predetermined association factors may be based on at least one of a geographical commonality, a number of common terms, a number of common suspects, a physical commonality, a number of recurring names, a type of crime, a type of event, a type of cyber address, a number of common aliases, a similar type of website, a similar type of event, a number of known suspects, a common crime scheme, a common analyst, a number of common analysts, a number of common words, a number of common names, a number of common events, a number of common keywords, a common background between a POI and an other POI, a keyword, a common criminal history between two POIs, at least one common friend between two POIs, a membership in a particular gang, a number of mutual friends between two POIs, a number of similar interests between two POIs, a commonality in victims between two POIs, the common crime scheme between two POIs, known information about the POI to the other POI, a known interaction to the other POI, a number of visits by the POI to a particular physical location, a frequency of visits by the POI to the particular physical location, a number of visits by the POI to a particular cyber location, a frequency of visits by the POI to the particular cyber location, a number of communication attempts between the POI and the other POI, a frequency of communication attempts between the POI and the other POI, a use of specific communication devices, an information about a means and methods of communication and an information on a pattern of communication.

The methods and the systems disclosed herein may be implemented in any means for achieving various aspects. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 illustrates the system overview of the network for law enforcement agents.

FIG. 2 illustrates the process of creating a profile in the network for law enforcement agents.

FIG. 3 is a representation of the relationship between the user-generated data, the analysis module and the existing data to form connections between profiles.

FIG. 3B illustrates a sliding scale model used by the analysis module to make a connection between two profiles.

FIG. 4 is a graphical representation of the degrees of separation between POI A 106A and various other profiles in the system.

FIG. 5 illustrates a graphical timeline representation of a set of phone records associated with POI A. A user of the system can scroll back and forth in the timeline and select a particular date for which he wants to view a list of all incoming and outgoing phone calls.

FIG. 6 illustrates the tracking function on the system that allows a set of users to track a particular profile and receive alerts as soon as the profile is updated.

FIG. 7 illustrates a formation of a group that links to multiple profiles, and may be tracked up multiple users who receive any updates done to the group or its constituents.

FIG. 8 illustrates a function of the analysis module whereby two profile may be compared, and a list of common links and similarities may be generated.

FIG. 9 is a graphical representation of a geographical location associated with POI 106A, also coupled with a timeline bar.

FIG. 10 is a graphical representation between a set of profiles in the system.

FIG. 11 illustrates how the system forms a connection between two profiles using the predetermined association factors.

FIG. 12 (12A and 12B) is a critical path flow illustrating the creation of a profile.

FIG. 13 (13A and 13B) is a another critical path flow that illustrates how a set of users are able to access and update to a particular profile.

Other features of the present embodiments will be apparent from the accompanying drawings and from the detailed description that follows.

### DETAILED DESCRIPTION

This disclosure relates generally to analysis of cyber data, and a data collected through cyber means and physical means, and in particular to sharing and managing a set of information and digital content obtained through legal means. In the following description, for the purposes of explanation, numerous specific details are set forth in order to provide a thorough understanding of the various embodiments. It will be evident, however, to one skilled in the art that the various embodiments may be practiced without these specific details.

System Overview

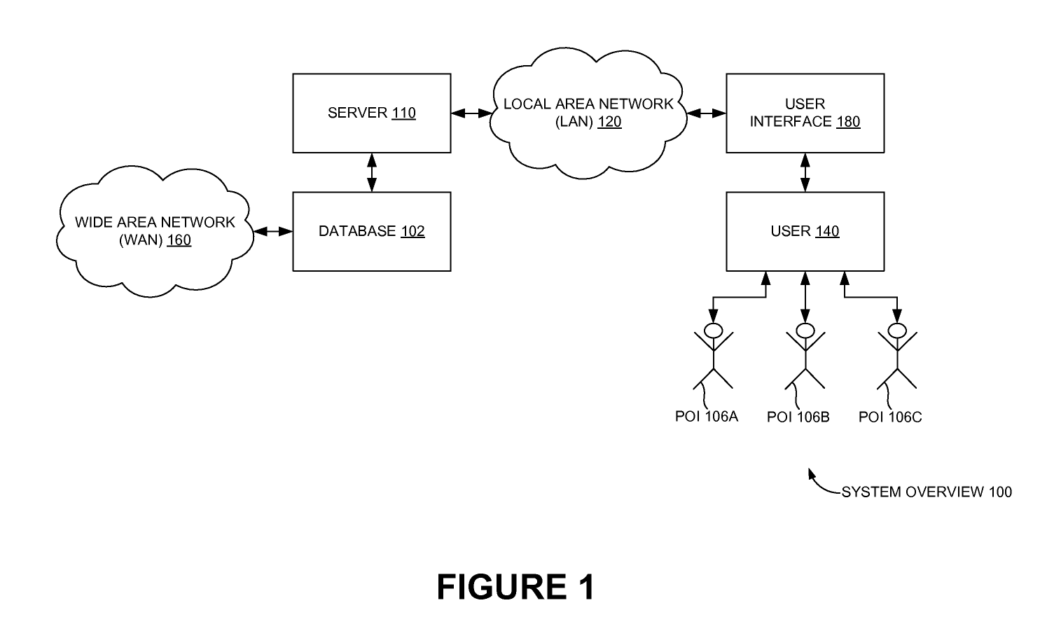

The application discloses a method to organize and share a set of lawfully intercepted data. The application would be especially helpful to a set of analysts who may need to conduct detailed analysis about the relationship of people involved in a particular event or transaction. For example, in one embodiment, the analyst may be a law enforcement agent who may use the system to find leads, and better understand the raw data collected by various law enforcement agencies. The system may also be a powerful tool that helps connect various law enforcement agencies and officials with one another and may increase the efficiency of the criminal justice system. As shown in FIG. 1, the system comprises of a user 140 who may be an analyst (e.g. a law enforcement agent, a management agent, a member of the FBI, the CIA, a social criminal organization, a financial analyst, a management analyst etc.) who may be assigned to a particular criminal and/or civil investigation. The analyst may want to organize a set of data related to a particular record. For example, the particular record may be a criminal investigation associated with a murder. The set of data related to the particular record may be a set of details related to the murder such as the time of the murder, the identity and description of the victim, a location of the murder, a set of interviews of witnesses of the murder, a set of police investigative clues, and a set of suspects. The analyst may also want to generate leads through the system that may lead to other potential targets. A potential target may be a suspect in a case above, or a person whose information the analyst is seeking to collect. As shown in FIG. 1, the user 140 may input this data into the network, and may then create a profile for this particular record 108. The user 140 may be able to collect the data and input the data into the system based on an electronic communication or cyber activity between two POIs. The user 140 may also be able to collect the data from a service provider network. The user 140 may also be able to collect the data through public and internet outlets. For example, the user 140 may have a warrant for a particular POI, and a set of cyber activity the particular POI may engage in. Based on limits set by the warrant, the user 140 may be able to monitor a set of cyber records and other cyber activity that the particular POI engages in. The user 140 may then collect this data found from the cyber activity and input it into a profile and/or other profiles with all lawfully intercepted data. In another example, the user 140 may be interested in a particular POI related to the murder mentioned above, and may want to gather a set of information related to the POI 106A. The user 140 views the system through the user interface 180 that connects to a Local Area Network (LAN) 120 that in turn connects to a server 110. The database 102 may also connect to a Wide Area Network (WAN) 160 to obtain information from the internet and other online sources. In one or more embodiments, the database 102 may be useful in data collection via legal means. For example, the user 140 may monitor the POI's cyber activity on the WAN 160 and collect information from the source. In another embodiment, the user 140 may search public records on the WAN 160 to look for information about an event or a POI. The server connects to a database 102 that stores the set of data related to the particular record and all other records in the system. These records may be accessible to a set of all users in the system, and the database may house many records and profiles. The metadata may be data about a data, and may describe a set of details regarding a delivery or an exterior of a data or a portion of a data.

The server may be any brand of server and any type of server computer, blade server or any other processing device capable to performing the data management and communication functions with any quantity of cores. For example, a six (6) core X86 Intel Quad Xeon MP, which may be programmed for any type of operating system (“OS”), e.g., Solaria, UNIX, LINUX, or other server computing OS. In one or more embodiments, the system may be run on an Intel86 based processor using Linux RHEL with 64 bit OS. The system may be run on a direct or NAS storage device or appliance. The system is not limited to Intel x86, Linux RHEL, Direct/NAS storages and can be implemented on any computer hardware, OS and storage devices. Any commercially available or proprietary design DPU may be used for this function given the adaptation and implementation of drivers specific to the actual device.

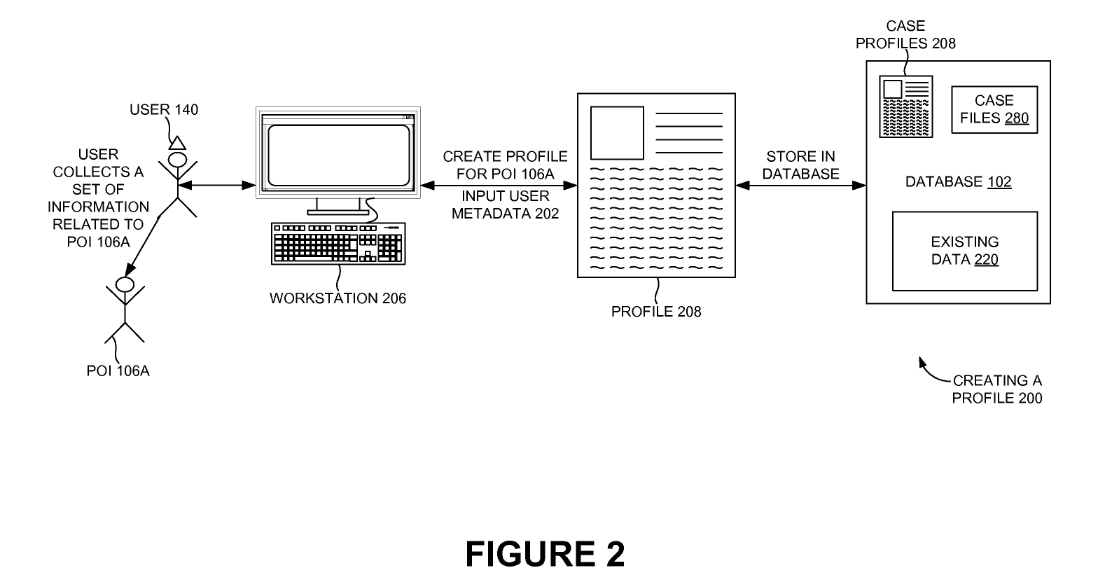

FIG. 2 is a system view illustrating a creation of a profile for POI 106A. In particular, FIG. 2 illustrates a database 102, an existing data 220, a profile 208, a user 140, a POI 106A, a user data 202, and a data processing unit 206.

In one embodiment, the user 140 may want to create a profile for POI 106A. The user 140 then uses a data processing unit 206 to input the data 202 into the database 102. The data may consist of a metadata (e.g. IP address, email address, cyber address recipient address, sender address, time of the email, time of the mail, information on a post card, etc.). The metadata may be an information about the data. The metadata may encompass a time and place that the data was received. The metadata also encompass a set of information related to the senders and receivers of the information, a time of a communication event, or where an information was collected from. For example, if an email is sent to the POI, the metadata may consist of the sender and recipient addresses of the email, an IP address and a time of the email among others. The data may also consist of a content. The content may be the substantive part of the data collected. The data may consist of the actual text of the email, attachments in the email and what the information actually says. In the previous example, the content may be the actual text of the email which may be a solicitation for a crime. The system may make a distinction between content and metadata. For example, in one embodiment, the user 140 of the system, upon searching for a particular record, may only be able to view the metadata associated with a particular profile. The metadata may also be a cyber name, a cyber address, contact list, a user login information, a chat IP address, a chat alias, a VOIP address, a web forum login, a website login, a social network login, a sender and/or receiver of a chat, a time of a chat conversation, a file name sent in a chat or an email or any other cyber communication, a number of files transferred in the cyber communication, a type of chat text, a name of an audio and/or video attachment sent in the cyber communication, a number of parties involved in a communication, a budget list, an avatar description associated with the cyber communication. The metadata may also be associated with voice and/or voice over IP communications. The metadata may also be associated with social networking sites, and may include a username, a time of a social networking communication or publication, a size of a social networking communication, a number of followers and others.

Similarly, the content may include the substantive portion of a record. In addition to the text of the communication, or a transcript of a recorded conversation, it may also include a text of an email attachment, a transferred file, a content of an uploaded or downloaded document/video or any other file, a pooled information between many users, a substance of social network communication, a tweet, a message exchanged between two parties, a substance of a text message, and any other communication. The content may also be a background of a POI, a crime profile of the POI, a racial profile of the POI, a family and friend circle of the POI, a history of criminal records of the POI, a criminal propensity of the POI, a modus operandi of the POI, and a police record data of the POI, a set of cyber communications associated with the POI, a set of internet chats associated with the POI, a set of social networking data associated with the POI, a content of telephony calls associated with the POI, a set of networking data associated with the POI, a chronological data associated with an event, a geographical data associated with the event, an identity of individuals associated with the event, a police tracking data associated with the event, a newspaper coverage of the event, a set of general information known about the event, a contact information associated with a group of individuals, an association between the group of individuals, a set of known information about the group of individuals, a known information about a gang, a latest update about the gang, the identity of individuals belonging to the gang, a set of data associated with a phone number, a set of data associated with a cyber communication, a set of data associated with a physical address, a set of data associated with the geographical location, a set of data associated with a web host, a set of data associated with a phone record or a set of data associated with a warrant. The content may be the substance of a cyber communication, an actual conversation, a physical communication and any other evidence gathered by the analyst.

The user may only be able to view the content associated with the email, and the rest of the data in the email only after being explicitly authorized by a creator of the profile. The creator of the profile may be the LEA or any other authorized user who has made the first profile for a particular record or POI. The workstation may access the database 102 through the LAN 120. The user 140 may then create a profile 208 for the POI 106A with the inputted data 202 and an existing data 220. The data processing unit may be a desktop computer, a laptop, a personal computer, a smart phone, a hand held device or a workstation unit. For example, the user 140 may be interested in creating a profile for a POI 106A and may have some physically collected research data on POI 106A. The user 140 who may create the profile may be known as a creator of the profile. He may then use his workstation that is connected to a local area network (LAN) to create the profile for POI 106A. To create the profile, the user 140 may input data that he has physically collected (202), and may also use an existing data already present in the server 110 and the database 102 to create the profile. For example, in the above mentioned criminal investigation associated with a murder case, a profile for the murder case may already be present in the database. The profile associated with the murder case may already contain information about a set of suspects, including POIA. The user 140 who is making the profile for POI 106A may then use the existing data contained in the profile for the murder case in addition to any physically contained data associated with POI 106A. Using the complete set of information, the user 140 may create the profile for POI 106A. When the user 140 makes the first profile for a POI or any other record, the user 140 may also be considered a creator of the profile. In another embodiment, the existing data may be a set of email conversations between POI 106A and an other POI. The set of email conversations may be part of another profile, or may exist in the server 110 as part of lawfully intercepted data. This existing data 220 may also be used to supplant an existing information to update and create the profile for POI 106A. The profile 208 may then be stored in the database 102 along with other case profiles 208, all other information stored in the database, including case files 280, and other lawfully intercepted data, and existing data 220.

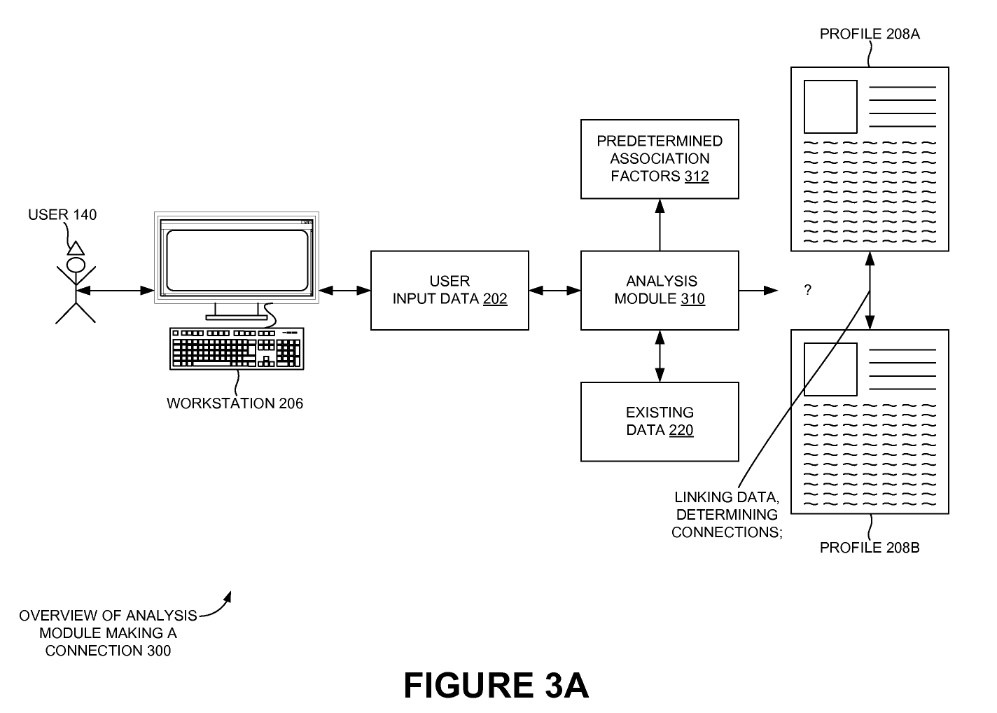

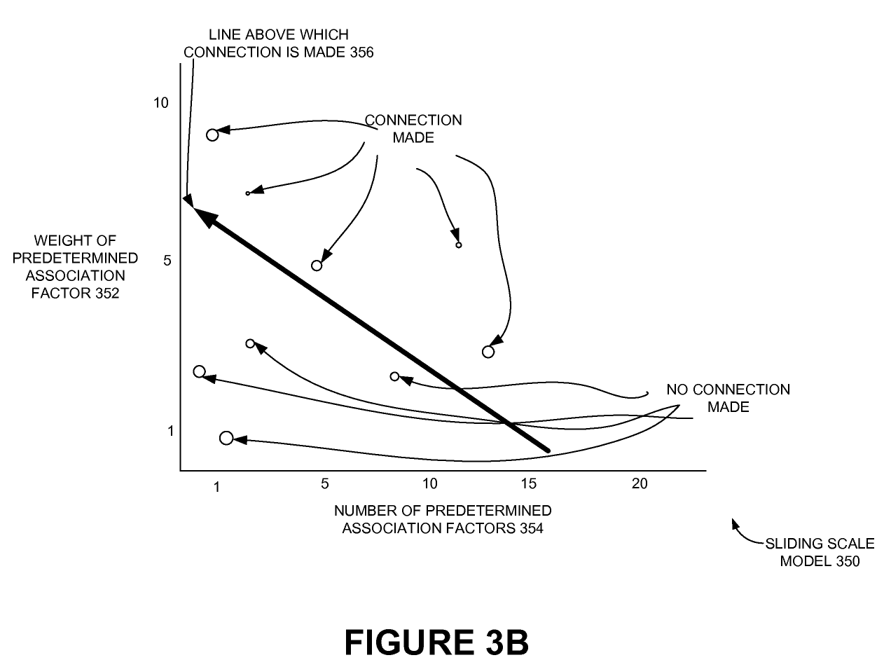

FIG. 3 is a representation of the relationship between the user-generated data, the analysis module and the existing data to form connections between profiles. FIG. 3 illustrates a user 140, a workstation 206, the user data 202, a predetermined association factor 312, an analysis module 310, the existing data 220, the profile 208A and another profile 208B.

In one or more embodiments, a user 140 may use the workstation 206, and user-generated data 308 to create the profile 208 for POI 106A. The user generated data may be inputted into the database 102. When the user-generated data is inputted into the server 110, the analysis module 310 may make use of a set of predicates described in the predetermined association factors 312 and a set of existing data 306 to makes connections between the profile 208A and the other profile 208B already present in the system 100. In one embodiment, the system 100 may make a connection between the profile 208A currently being made for POI 106A and an existing profile in the database 102. The analysis module 310 may make a connection between the profile 208A and the existing profile based on a number and a weight attached to a set of predetermined association factors. For example, a predetermined association factor relating to the same case may be allotted a high weight, such that when two profiles relate to a same event or investigation, the analysis module 310 may automatically form a connection between the two profiles. In one or more embodiments, the user 140 may allot a weight to a set of different predetermined association factors that the analysis module 310 may use to make connections between two profiles. For example as discussed above, the user may be given a scale of 1-10 to allot weights to various predetermined association factors. In one embodiment, the user may give a high weight of 9 to a predetermined association factor that links two profiles together when both profiles are related to the same case or investigation. In one embodiment, the profile 208A may be associated with POI 106A who may be a suspect in the above mentioned murder case investigation. POI 106 B, may also be a suspect in the same murder case investigation. Given that the predetermined association factor has a weight of 9, the analysis module 310 may make a connection between the profile 208 associated with POI 106A, and the other profile 208B associated with POI 106B. In another embodiment, a user may give a weight of 3 when a predetermined association factor links two profiles together when both profiles are associated with a particular geographical location. Since the weight given to this predetermined association factor is not that high, the analysis module 310 may not automatically link the profile 208A with the profile 208B having the same geographical location automatically, but if there are many other predetermined association factors that match between the profile 208A and the other profile 208B, the analysis module 310 may still make a connection between the profile and the other profile. In one or more embodiments, the analysis module 310 may use a sliding scale model such that two profiles may be linked when they have at least one predetermined association factor having a high weight, or if there are many predetermined association factors between two profiles, but all have low weights, the analysis module 310 may still make a connection between both profiles.

FIG. 3B illustrates a sliding scale model used by the analysis module to make a connection between two profiles. FIG. 3B illustrates a weight of the predetermined association factor 352, a number of predetermined association factors 354 and a line above which a connection is made 356.

In one or more embodiments, the user 140 may set weights 352 to a set of predetermined association factors. For example as discussed above, a predetermined association factor that links two profiles together when both profiles are associated with the same case or investigation may receive a high weight of 9 from the user 140, whereas an other predetermined association factor that links two profiles together when both profiles are associated with the same geographical location may only receive a low weight of 3. In another embodiment, yet another predetermined association factor that links two profiles together when both profiles have at least one common known associate may receive a weight of 4, while another predetermined association factor that links two profiles together when both profiles have at least five common known associates may receive a weight of 8. In one or more embodiments, predetermined association factors related to common interests, geographical location, crime type, criminal background may receive low weights of 4 or less than 4. As per the sliding scale model illustrated in FIG. 3B, when a profile does not have many predetermined association factors, but has at least one predetermined association factor having a weight of 9, the analysis module 310 may automatically link the two profiles together even though there is only one predetermined association factor. However, the analysis module 310 may also link two profiles together when there a larger number of common predetermined association factors 354 between two profiles, even if none of them has a high weight. For example two profiles may have a common geographical location, having a predetermined association factor weight of 3, one common known associate, having a predetermined association factor weight of 4, a common background, having a predetermined association factor weight of 2, and a common gang association, having a predetermined association factor weight of 5. As illustrated by the sliding scale model shown in FIG. 3B, even though none of the above mentioned predetermined association factors have high weights, the analysis module may still link the two profiles together because the two profiles have a large number of predetermined association factors in common. The line above which a connection is made 356 may determine when a connection is made between a profile 208 and any other profile in the database 110.

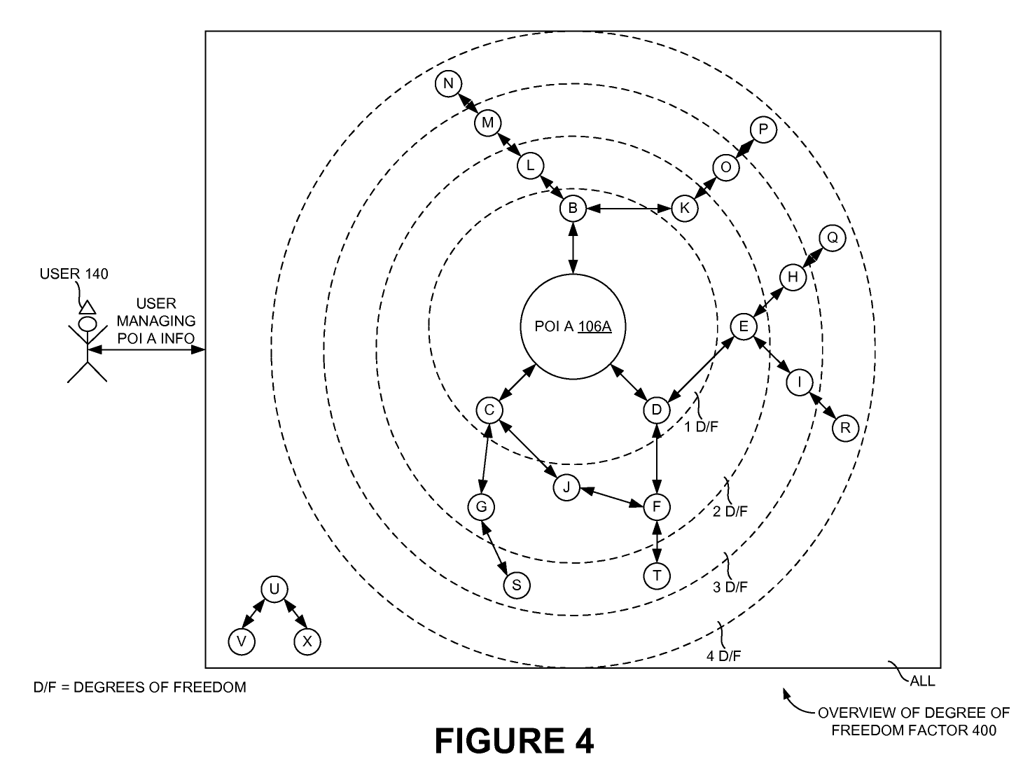

FIG. 4 is a graphical representation of the degrees of separation between POI A 106A and various other profiles in the server 110. FIG. 4 illustrates the user 140, the profile 208 associated with POI 106A and a set of known connection between profile POIA 106A and a set of profiles associated with other POIs: B, C, D . . . X.

In one or more embodiments, POI A 106 A may be connected to profiles B, C and D. Profile D may be connected to profile F and profile E. Profile E may be connected to Profile H and Profile I. In one embodiment, as per FIG. 4, Profile I may be three degrees of separation (D/S) from Profile A. Similarly, as per FIG. 4, Profile R may be four D/S from Profile A. The degrees of separation between two profiles may be a predetermined association factor such that two profiles having a D/S of 1 may be given a medium to high weight of 6, while two profiles having a D/S of 4 may be given a low weight of 1. Profile U may be unrelated to Profile A, and has a D/S of 0. In another embodiment, a graphical representation between a set of all connections between POI 106A and another profile may show a connection and an interaction between a set of profiles. The graphical representation, such as one shown in FIG. 4, may be part of profile 208 or another profile to show a larger interaction and relationship between profiles. Such a graphical representation, make help the user 140 to make further connections between profiles. For example, the user 140 may not have realized that Profile 106 A and a profile F are only three D/S apart. Such a graphical representation may help the user generate more leads and may aid his criminal investigation better.

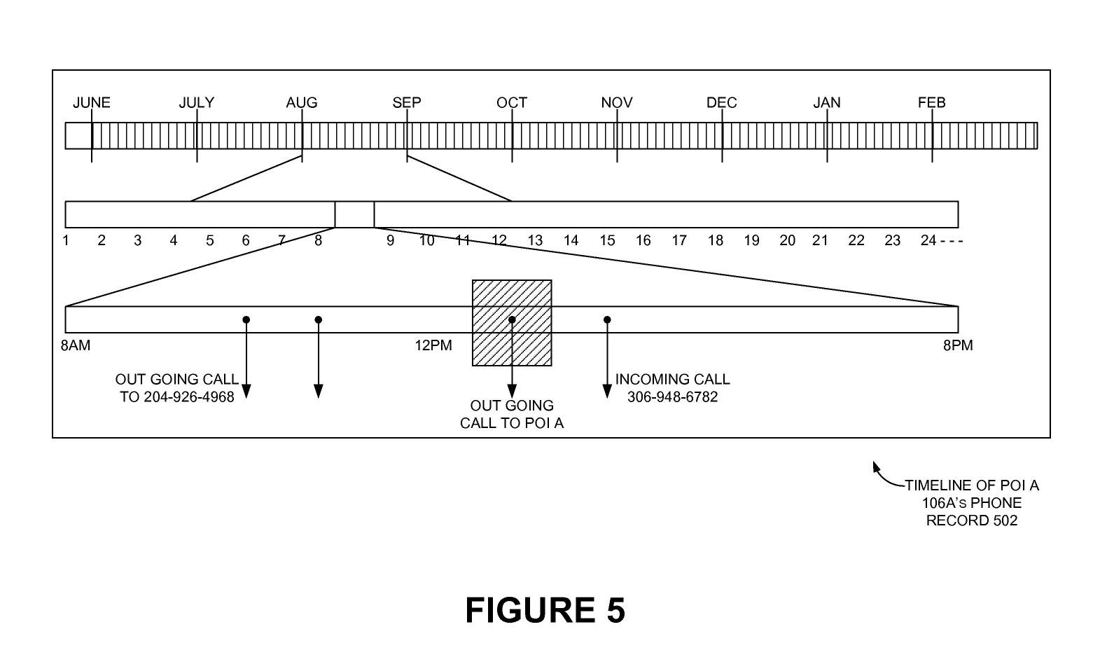

FIG. 5 illustrates a graphical timeline representation of a set of phone records associated with POI A. A user of the system can scroll back and forth in the timeline and select a particular date for which he wants to view a list of all incoming and outgoing phone calls.

In one embodiment, the server 110 may graphically cluster a set of data associated with the profile 208 related to POI 106A and generate a graphical timeline of various categories of information. For example, as illustrated in FIG. 5, the server 110 may generate a timeline of a set of phone records associated with POI 106A. A user 140 may be able to use a sliding timeline tab to zoom into a particular timeline of interest and may view a set of detailed phone records. For example, in one embodiment, the user 140 may be interested in a set of phone records for the month between August and September of a particular year. The user 140 may be further interested in the day August 8 between the times of 8 AM to 8 PM. By using the sliding timeline bar, the user 140 may select a particular timeline of interest to view an entire set of phone records and the user may then view the outgoing and incoming calls made by the POI 106A. Such a graphical representation may make it easier for the user 140 to make new connections and leads to evidence or other suspects. For example, the outgoing call made by the POI 106 A may lead the user to POI, and may eventually help the criminal investigation.

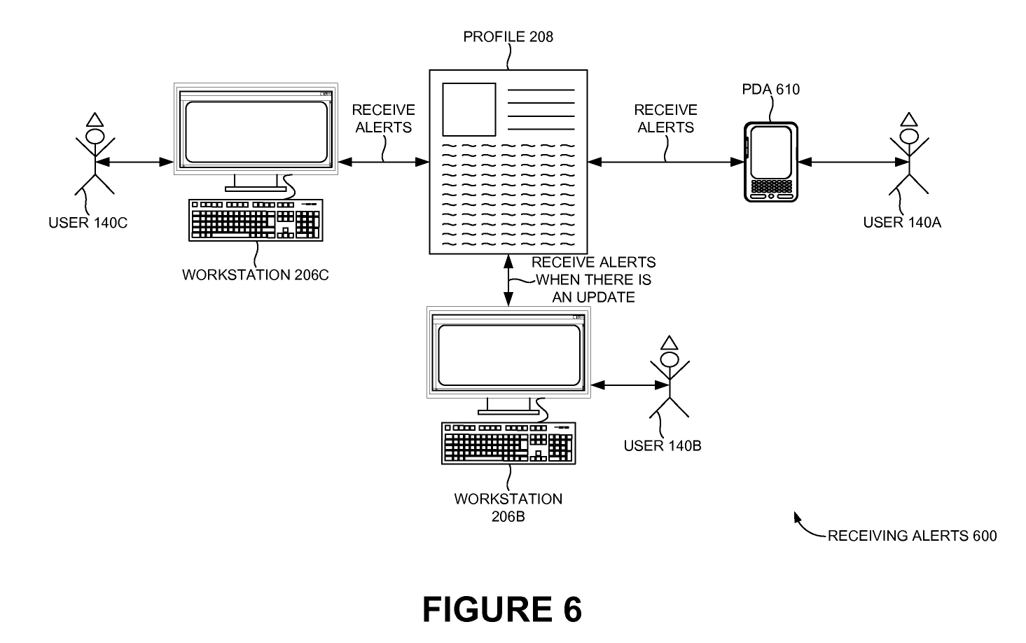

FIG. 6 illustrates the tracking function that allows a set of users to track a particular profile and receive alerts as soon as the profile is updated. A user that tracks a profile may also be referred to as a tracker of a profile. FIG. 6 illustrates a user 140 A, another user 140B and yet another user 140C, a workstation 206A, another workstation 206B and yet another workstation 206C and a profile 208.

In one or more embodiments, the user 140A, another user 140B and yet another user 140C may all track the profile 208. When the profile 208 is updated with new information, all users tracking the profile 208 may receive an alert indicating that the profile 208 has been updated and the updated information. In one embodiment, the user 140A may update the profile 208 with a most recent spotted location of POI 106A. Users 140B and 140C may also be interested in POI 106A. For example, User 140B may be working on another criminal investigation in which POI 106A is also a suspect for, or User 140B may be working on another aspect of the same criminal investigation as User 140A. User 140B may choose to track the profile 208 associated with POI 106A. As soon as the profile 208 is updated with POI 106A's most recent spotted location, the update may be communicated to User 140B through an alert. A set of users tracking the profile 208 may all receive the alert. In one or more embodiments, the user 140 may track the profile and receive alerts through a workstation. In one or more embodiments, the user 140 may access the database and the profile and the existing data through a hand held device, a PDA device, a laptop, a desktop computer, a cell phone and/or a smartphone device. In one or more embodiments, the user 140 may receive alerts on his PDA 610 or any other smartphone device. In another embodiment, the creator of the profile, in this case, User 140A may manually select what users may receive certain alerts. For example, user 140A may want to limit the set of alerts sent to trackers of the profile 208 based on a security level of the user tracking the profile 208. For example, user 140A may allow a known user 140B, who may be working on the same case to receive certain updates, but may not allow user 140C, who may be an unknown user to receive all updates. In one or more embodiments, the user 140B may receive all updates made to the profile 208, but user 140C may only receive more generic updates made to the profile 208. Conversely, in another embodiment, a user tracking the profile 208 may also choose to only receive alerts on significant updates to the profile 208. For example, user 140 B may only want to receive updates related to POI 106 A's location, but may not want to receive updates on POI 106A's set of phone records. User 140 B may then be able to change a set of preferences and only receive relevant updates in the categories of information desirable. In one embodiment, the user may choose to receive updates when “Geographical location” section of the profile 208 is updated, but may choose to not receive an update when a “Biographical information” section of profile 208 in updated. The alert may be an email, a text message, a consolidated report in an email or a consolidated weekly report by mail.

In one or more embodiments, the system may also include a means to track a set of updates made by a set of users. For example, if multiple users performed updates on a particular profile, the system may designate updates made by various users through a color coding. The system may also measure the accuracy of the particular user performing the update to track an accuracy of a particular user. For example, user A may be a creator of a profile. User B may be have access to the profile and may have privileges to update the profile based on a role based access control. In one or more embodiments, role based access control may allow all member of a particular organization complete access to a particular profile. User B may then input new data into the profile. The update may be color coded by the system to represent the new data inputted by User B in red color, for example. The system may then determine an accuracy of the update based on the set of accuracy factors associated with user B's previous updates on other profiles in the system. The system may determine the accuracy based on a set of accuracy factors such as consistency of data, a set of conflicting information and prior matching patterns of data. For example, User B may have added particular useful information to prior profiles. Based on past success, User B's accuracy may reflect higher on the present update, in one or more embodiments.

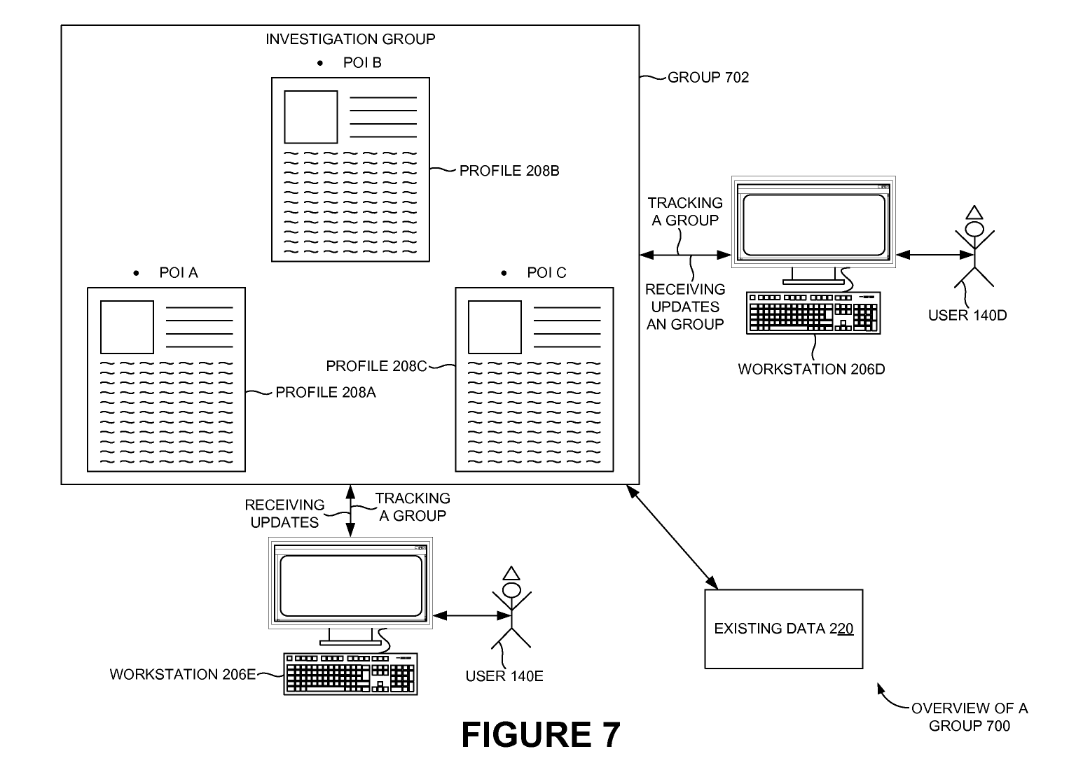

In one or more embodiments, the system may perform a metaheuristic analysis on a new information against existing data in the database. Metaheuristics may refer to any computational strategies used by the system to improve accuracy and legitimacy of the information presented. For example, the system may use a computational strategy or algorithm to independently determine an accuracy or legitimacy of the new information. The system may also use complex algorithms to determine a consistency of data and other variables to match and compare data. FIG. 7 illustrates a formation of a group that links to multiple profiles, and may be tracked by multiple users who receive any updates done to the group or its constituents. FIG. 7 illustrates a profile for an investigation group 702, a profile 208A for POI 106A, a profile 208B for POI 106B and a profile 208C for POI 106C, a user 140D, a user 140E, a workstation 206D and another workstation 206E and en existing data 220.

In one or more embodiments, a profile for an investigation 702 may be created. The profile for the investigation group 702 may link to a set of other profiles. For example, the profile for the investigation group 702 may link to a profile 208A created for POI 106A, a suspect in the investigation, another profile 208B created for POI 106b and yet another profile 208C created for POI 106C. User 140D and user 140E may be tracking the profile for the investigation group 702. In one embodiment, the user may 140D may receive an alert when the profile for the investigation group is updated. In another embodiment, the user 140D may automatically also receive an update when a constituent profile, for example profile 208C is also updated because profile 208C is linked and referenced to in the profile for the investigation group 702.

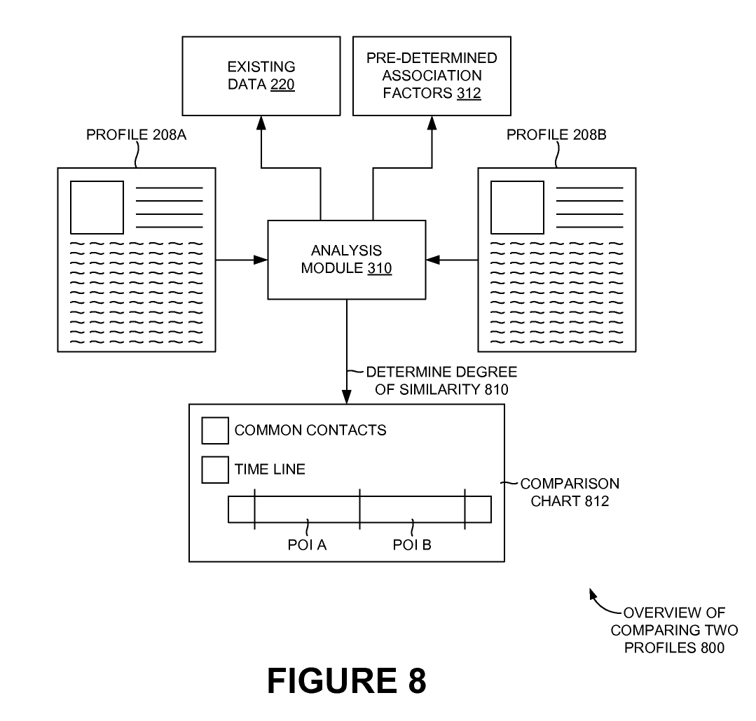

FIG. 8 illustrates a function of the analysis module whereby two profiles may be compared, and a list of common links and similarities may be generated. FIG. 8 illustrates the profile 208A, the other profile 208B, the analysis module 310, the existing data 220, the predetermined association factors 312 and a comparison chart 812.

In another embodiment, a user 140 may be interested in visually comparing profile 208A and the other profile 208B. For example, the user 140 may want to graphically see the similarities and differences between the two profiles. The two profiles of interest may be profiles of suspects in a particular criminal investigation. The user 140 may want to create a timeline of phone records of both suspects, to see if the suspects possibly communicated with each other. In one embodiment, the user 140 may want to compare the two profiles to see the list of common contacts between profile 208A and profile 208B. In one or more embodiments, the user may be interested in seeing a set of analytics comparing the profile 208A with the profile 208B. The analysis module may draw from the set of existing data 220 and the predetermined association factors 312 to make connections between the two profiles. In one embodiment, the analysis module 310 may use the predetermined association factors to generate a degree of similarity value 810. For example, profile 208A and profile 208B may be both associated with the same murder trial, both suspects may be members of the same gang, and may have been from the same geographical location. In keeping with these predetermined association factors, the analysis module may generate a value for degree of similarity based on a number and a weight allotted to each predetermined association factor. The degree of similarity value may be helpful to the user 140 to determine how similar or dissimilar two profiles may be. Similarly, in another embodiment, the user may want to graphically map the similarities and dissimilarities between profile 208A and profile 208B. In this case, the server 110 may allow the user to view both profiles simultaneously and may help the user 140 to graphically compare and observe the similarities and differences in the two profiles.

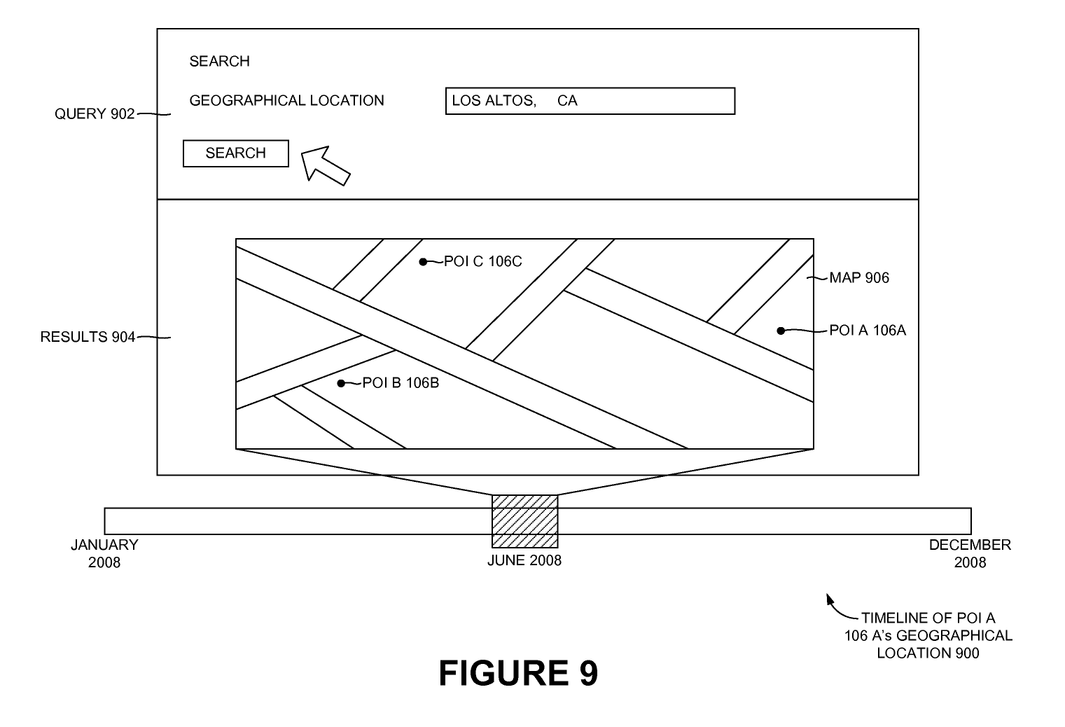

FIG. 9 is a graphical representation of a geographical location associated with POI 106A, also coupled with a timeline bar. FIG. 9 illustrates a graphical illustration of a query entered by the user 140, a set of results 904 and a timeline of POI A 106A's geographical location.

In one or more embodiments, the user 140 may want to search for a set of profiles in the database, and limit the search by geographical location. The query may limit the search by geographical location, name, time, specific profiles, background, crime area, investigating officer, creator of profile, another criteria. In one or more embodiments, the workstation 206 may display the set of results graphically. For example, when the user 140 searches for the set of profiles by geographical location, in this case Los Altos, Calif., the server 110 may return results 904 with a map of Los Altos, Calif., and may list a set of profiles of POIs associated with Los Altos, Calif. to the user 140 for display. In one or more embodiments, the user 140 may be an investigating officer in the murder criminal investigation mentioned above, and may want to search a list of all suspects who have profiles in the database 102 who may be located close to the crime scene. In another embodiment, the user 140 may want to limit the query 902 by weapon type and geographical location in the same murder criminal investigation mentioned above, and the server 110 may return a smaller more filtered set of results 904. In another embodiment, the user 140 may be able to use the timeline feature to limit the query further by time and geographical location. For example, the user 140 may not only want to know the current locations of possible suspects in Los Altos, Calif., but may also want to specifically search the set of profiles in the server 110 in June 2008 who may have been associated to Los Altos, Calif. The user 140 may thus be able to visually analyze and organize the set of data, and may use this information to better investigate the case.

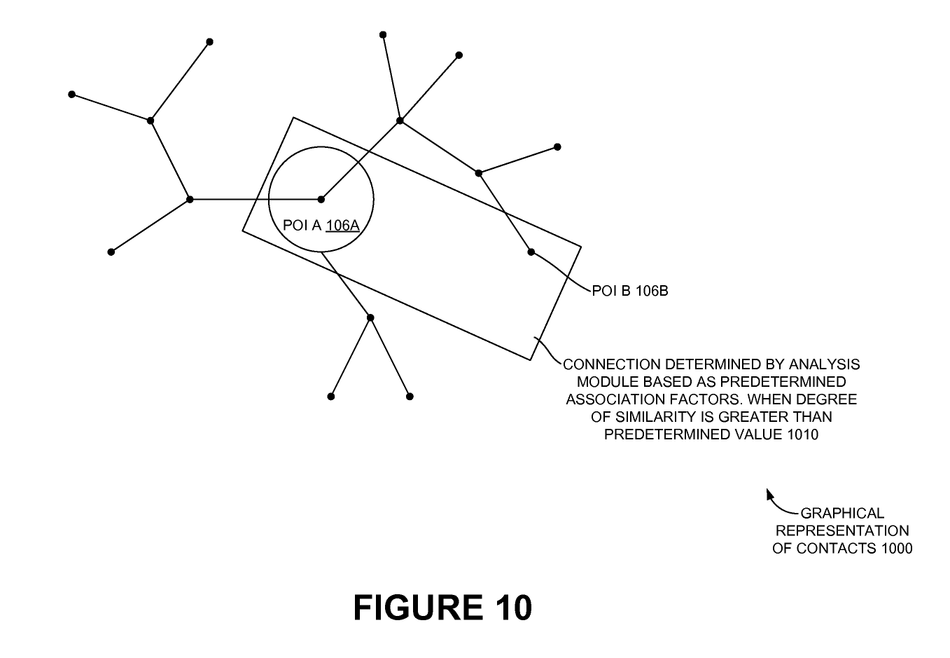

FIG. 10 is a graphical representation between a set of profiles in the server 110. FIG. 10 illustrates POI 106A and POI 106B, and forming a connection based on the set of predetermined association factors.

In one or more embodiments, the user 140 may want to see a set of connections around POI 106A. The user may want to map a set of contacts associated with POI 106 A, and may want to analyze and organize the set of data visually. The user may be able to see a set of POI 106A's contacts graphically and may be able to see a set of contacts of a contact of POI 106A. In viewing the graphical representation, the user 140 may be able to make connections between POI 106A and POI 106B. In another embodiment, the server 110 may also use the predetermined association factors to visually highlight certain connections when the degree of similarity between two profiles is higher than a threshold value. As mentioned above, the user 140 may want the server 110 to highlight certain connections visually when the value for degree of similarity is greater than 8. The value for the degree of similarity may be calculated using a number of applicable predetermined association factors and a weight accorded to a particular predetermined association factor. In FIG. 10, the server 110 may automatically highlight a connection between POI 106A and POI 106B because the server 110 may have determined that the degree of similarity between both profiles is greater than 8. In another embodiment, even if the server 110 has not highlighted the particular connection, the user 140, based on his own knowledge and preference may highlight the particular connection. In another embodiment, the server 110 may have a means of auditing a set of all activities performed by the user 140. For example, in the previous example, if user 140 highlighted a particular connection, a continuous audit record would keep track of this particular highlighting action, and a set of all other actions done by the user. For example, if the user updated the profile 208 with additional information, the audit record may keep track of what was added to the profile along with the login date and time of the entry. In another embodiment, the system 100 may also record in the audit record a set of changes made by the user 140. The set of changes may be an edit, an entry, a deletion, an uploaded material, a change to privacy options or a change to security options.

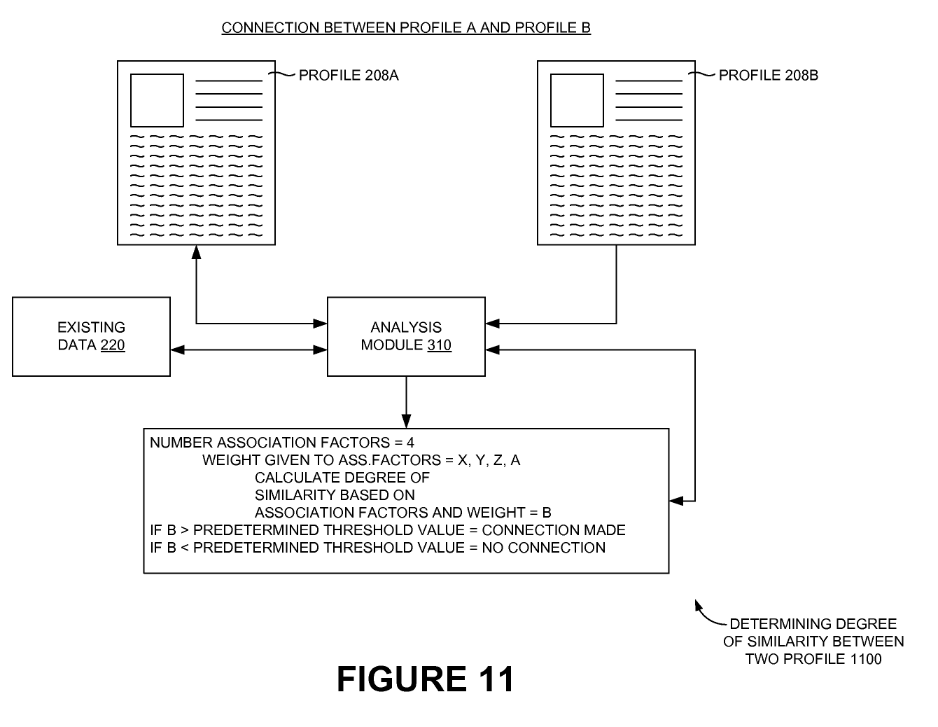

FIG. 11 illustrates how the system 100 forms a connection between two profiles using the predetermined association factors. FIG. 11 illustrates a profile 208A, an other profile 208B, the existing data 220 and the analysis module 310.

In one or more embodiments, the analysis module 310 may make connections based on determining a degree of similarity between a particular profile and another profile. For example, the profile 208A and the other profile 208B may have four applicable predetermined associations based on geography, background, common case and 1 common contact. The user 140 or the analysis module 310 may have accorded a weight of 3 to geographical location, 2 to background, 9 for common case and 5 for 1 common contact. In one embodiment, the analysis module may calculate the degree of similarity factor by simply averaging out the 4 numbers, in this case, 4.75. In another embodiment, the analysis module may use a more complicated algorithm to find the degree of similarity. The analysis module may use a median, or a statistical analysis to arrive at the value for the degree of similarity. The user 140 may have set the value for the predetermined threshold value to be 7. In this case, in comparing Profile 208A and profile 208B, the connection may not be highlighted since the degree of similarity is smaller than 7. In another embodiment, as discussed above, in the sliding scale model shown in FIG. 3B, even if the degree of similarity is small, the connection may still be highlighted because one predetermined association factor has a high weight of 9. The user 140 may be able to select, or program the server 110 based on his own preferences. The analysis module 310 may make connection based on these preferences.

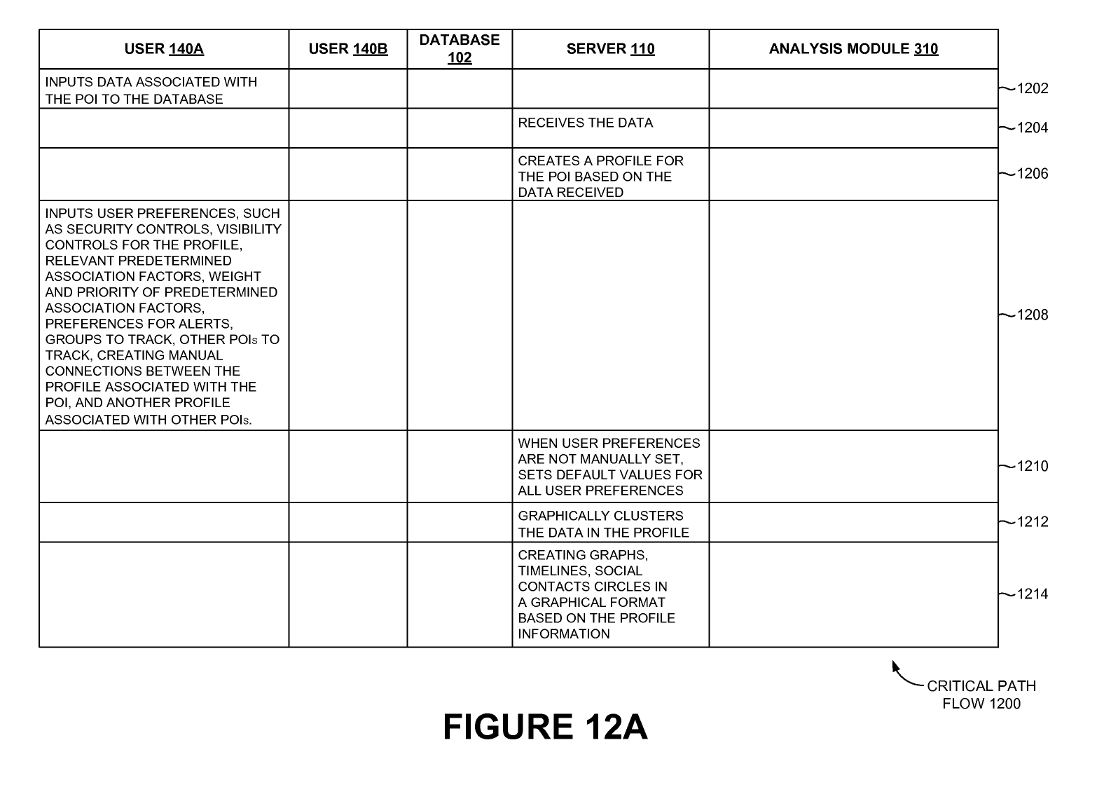

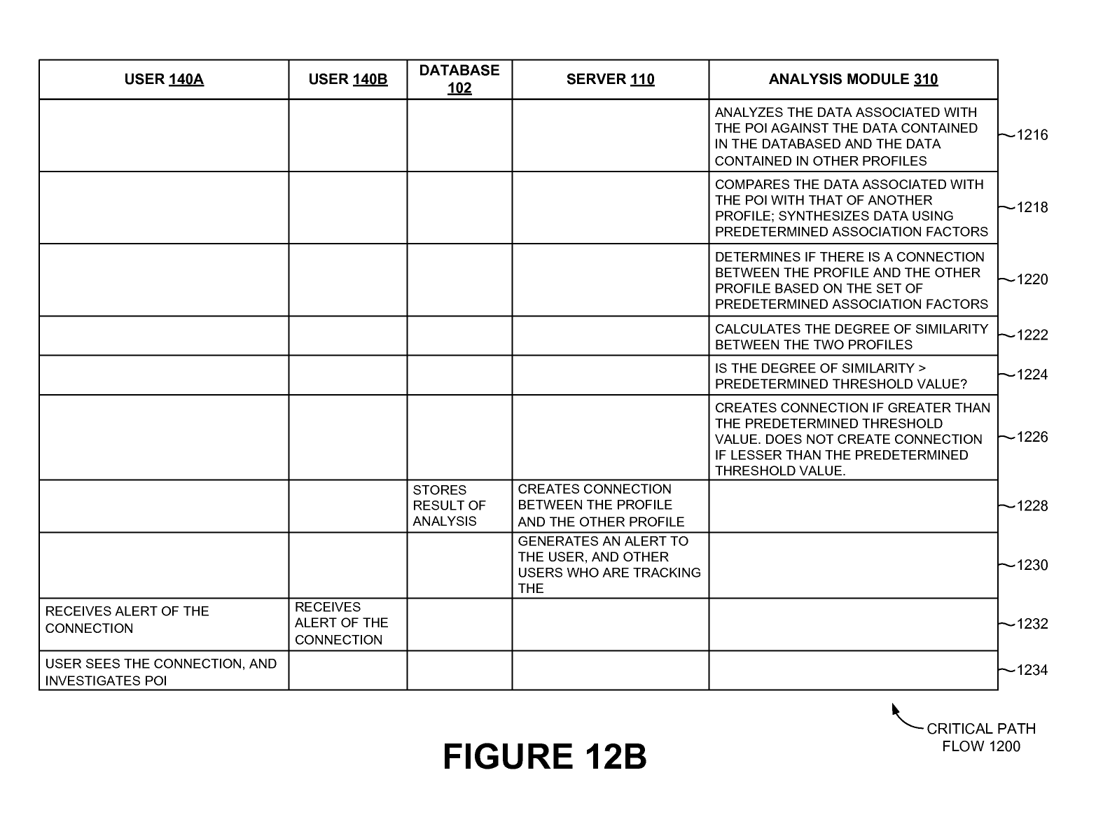

FIG. 12 (12A and 12B) is a critical path flow illustrating the creation of a profile. FIG. 12 illustrates user 140A, user 140B, the database 102, the server 110 and the analysis module 310.

In one embodiment 1202, the user 140A may input a data associated with a particular POI to the server 110. In 1204, the server 110 may receive the data. In 1206, the server 110 may create a profile for the particular POI based on the data received. In 1208, the user 140A may input user preferences such as security controls, visibility controls for the profile, relevant predetermined association factors, weight of predetermined association factors, preferences for alerts, groups to track, other profiles to track, creating manual connections between the profile associated with the POI and another profile, and other user preferences. In 1210, the server 110 may set default values for all user preferences when the user 140 has not manually set user preferences. In 1212, the server 110 may graphically cluster the data in the profile 208. In 1214, the server 110 may create graphs, timelines and social contacts based on the data of the profile 208. In 1216, the analysis module 310 may analyze the data against the data contained in the database and data of other profiles in the server 110. In 1218, the analysis module 310 may compare the data with that of other data contained in other profiles and may synthesize the data using predetermined association factors. In 1220, the analysis module 310 may determine a connection between the profile and another profile based on the set of predetermined association factors. In 1222, the analysis module 310 may calculate the value for degree of similarity between the profile 208 and other profiles in the server 110. In 1224, the analysis module 310 may determine if the value for degree of similarity is greater than the predetermined threshold value. In 1226, the analysis module 310 may create a connection between the particular profile 208 and any other profile if the value for degree of similarity is greater than the predetermined threshold value. If the value for the degree of similarity is lower than the predetermined threshold value, then the analysis module 310 may not create a connection. In 1228, the server 110 may create a connection between the profile and any other profile in the server 110 based on the analysis module 310. In 1228, the database 102 also stores the results of the analysis. In 1230, the server 110 may generate an alert to the user 140 and all other users who may be tracking the particular profile 208. In 1232, an other user 140B may receive an alert of the connection. In 1234, the user 140A also may receive an alert of the connection made. In 1226, the user may see the connection made by the analysis module 310, and may further investigate all the other profiles to which the connections are made to. The user may choose to delete some connections, and follow other connections based on a discretion of the user 140A.

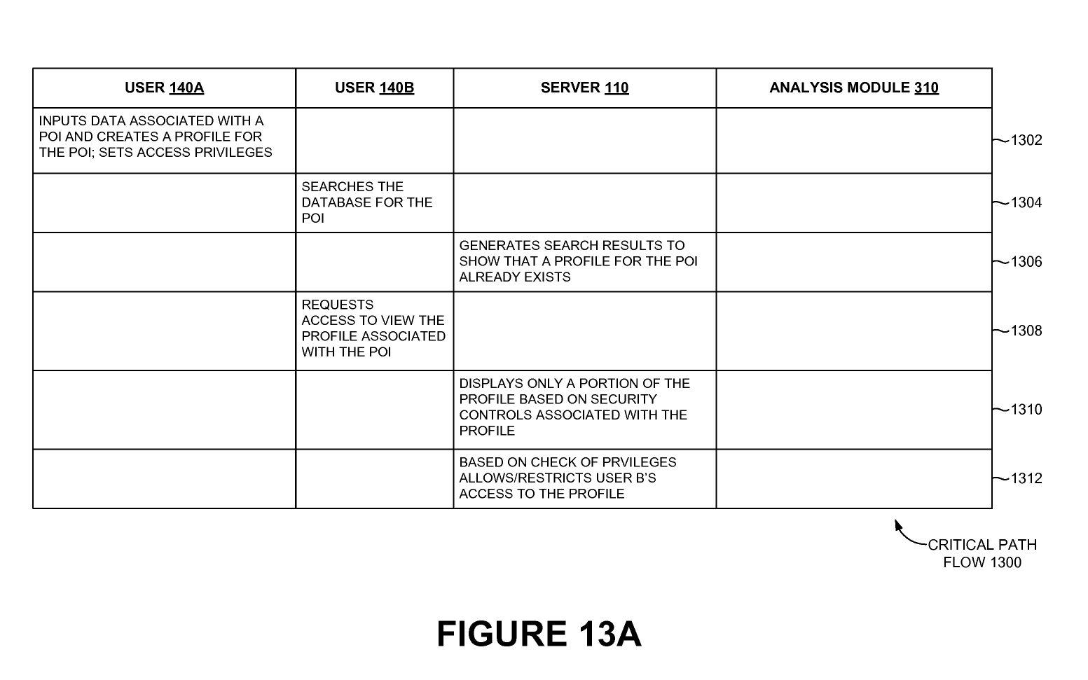

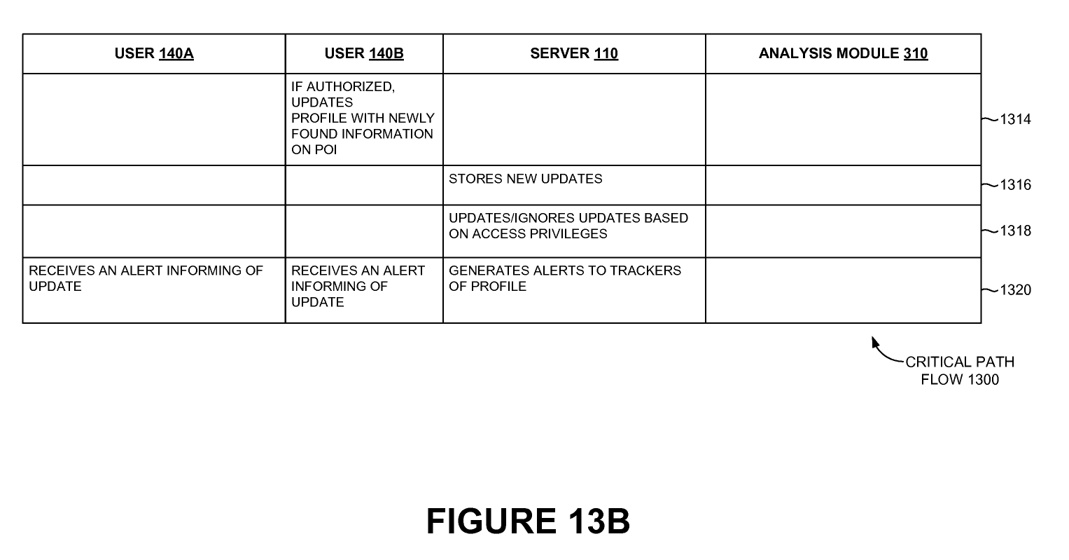

FIG. 13 (13A and 13B) is another critical path flow that illustrates how a set of users are able to access and update to a particular profile based on a role based access control model. Role based access control may be a system set access privilege determining what access and update privileges a member of a particular group may have. FIG. 13 illustrates a relationship between user 140A, user 140B, the server 110 and the analysis module 310.

In one embodiment, 1302, the user 140A may input the data associated with the POI and may create a profile for a particular POI. In 1302, the user 140A may also set access privileges that may allow a particular user, or a set of other users to access and/or update the page. The user 140A may allow any user affiliated with a certain group to access and update a profile. In contrast, the user 140 may not allow any user of another group to access or update. In yet others, the user 140 may allow users of a particular group to access but not update the profile. In 1304, the user 140B, may search the database 102 for the POI 1301. In 1306, the server 110 may generate a search result to show that a profile for the POI 1301 already exists. In 1308, the user 140B may request to access the profile associated with POI 1301. In 1310, The server 110 may display only a portion of the profile associated with POI based on a set of security controls associated with the profile. In 1312, the server 110 may check the access privilege and may allow or restrict the user 140B's access to the profile. In 1314, the user, if allowed to update to the profile, may update the profile associated with POI with new information. In 1316, the server 110 may store the new updates made by the user 140B. In 1318, the server 110 may update or ignore the update made by the user 140B based on a response of the user 140A. In 1320, the server 110 may send an alert to user 140A, user 140B and all other users tracking the profile associated with POI. Also in 1320, the users 140A and user 140b may receive an alert informing them of the update.

Although the present embodiments have been described with reference to specific example embodiments, it will be evident that various modifications and changes may be made to these embodiments without departing from the broader spirit and scope of the various embodiments.

What is claimed is:

1. A method comprising:
organizing a data associated with a record in a database;
creating a profile based on the data associated with the record;
graphically clustering the data associated with the record in the profile;
graphically linking the data with an other data of an other profile based on a set of predetermined association factors; and
determining a connection between the profile and the other data.

2. The method of claim 1 wherein the record pertains to at least one of a person of interest (POI), an employee of a corporation, a criminal investigation, an event, a group of individuals, a gang, a telephony number, a cyber name and address, a physical address, a website, a cyber server address, a web host, a phone record and a warrant.

3. The method of claim 1 wherein the set of predetermined association factors is based on at least one of a geographical commonality, a number of common terms, a number of common suspects, a physical commonality, a number of recurring names, a type of crime, a type of event, a type of cyber address, a number of common aliases, a similar type of website, a similar type of event, a number of known suspects, a common crime scheme, a common jurisdiction area, a common analyst, a number of common analysts, a number of common words in the cyber activity, a number of common words between the records, a number of common names, a number of common events, a number of common keywords, a common attribute between a POI and an other POI, a keyword, a common criminal history between two POIs, at least one common friend between two POIs, a common link between two POIs, a membership in a particular gang, a number of mutual friends between two POIs, a number of similar interests between two POIs, a commonality in victims between two POIs, the common crime scheme between two POIs, known information about the POI to the other POI, a known interaction to the other POI, a number of visits by the POI to a particular physical location, a frequency of visits by the POI to the particular physical location, a number of visits by the POI to a particular cyber location, a frequency of visits by the POI to the particular cyber location, a number of communication attempts between the POI and the other POI, a frequency of communication attempts between the POI and the other POI, a use of a specific communication device, an information about a means and methods of a communication and an information about a pattern of communication.

4. The method of claim 1 further comprising:
authenticating a set of users to access a particular profile based on a role based access control;
tracking the particular profile based on the role based access control; and
generating an alert to the set of users tracking the particular profile.

5. The method of claim 1 wherein the data associated with the record is at least one of a metadata and a content.

6. The method of claim 5 wherein the metadata is at least one of an information about a location of the POI, an information about a whereabouts of the POI, a geographical location of the POI, a time and location of the POI, an information about an IP packet, an information about a type of data collected, an IP information, a cyber address, an event information, a geographical information about an event, a source and destination IP address of a cyber activity, a version, a length, a set of cyber options, a padding information , error correction information, identification of a sender of an email, identification of a receiver of a cyber communication, a flag associated with a cyber communication, a protocol information, a subject line of a cyber communication, an attachment information, a routing information and a proxy server information, a telephony record, a buddy list, a contact list, an avatar, a social networking data and address of a website.

7. The method of claim 5 wherein the content is at least one of a background of a POI, a crime profile of the POI, a racial profile of the POI, a family and friend circle of the POI, a history of criminal records of the POI, a criminal propensity of the POI, a modus operandi of the POI, and a police record data of the POI, a set of cyber communications associated with the POI, a set of internet chats associated with the POI, a set of social networking data associated with the POI, a set of telephony calls associated with the POI, a set of networking data associated with the POI, a chronological data associated with an event, a geographical data associated with the event, an identity of individuals associated with the event, a police tracking data associated with the event, a newspaper coverage of the event, a set of general information known about the event, a contact information associated with a group of individuals, an association between the group of individuals, a set of known information about the group of individuals, a known information about a gang, a latest update about the gang, the identity of individuals belonging to the gang, a set of data associated with a phone number, a set of data associated with a cyber address, a set of data associated with a physical address, a set of data associated with the geographical location, a set of data associated with a web host, a set of data associated with a warrant.

8. The method of claim 1 further comprising:
organizing and displaying the data based on a set of user-defined preferences,
wherein the set of user-defined preferences is at least one of a display option, a profile-security option, a profile-display option and association management option;
graphically representing the data associated with the profile; and
creating a graphical timeline of the data associated with the profile.

9. The method of claim 1 further comprising:
synthesizing a category of information in the profile with the category of information in the other profile;
measuring a degree of similarity in the category of information in the profile with the other profile,
wherein the degree of similarity is based on a number and a frequency of predetermined association factors that are applicable between the profile and the other profile;
graphically representing the connection between the profile and the other profile within the category of information;
highlighting the connection when the degree of similarity is higher than a predetermined threshold value,
wherein the predetermined threshold value is based on at least one of a weight given to a particular predetermined association factor, a number of matching predetermined association factors and a user-determined predetermined association factor; and
generating an alert to at least one of a creator and a tracker of the profile when the degree of similarity is higher than the predetermined threshold value.

10. The method of claim 1 further comprising:
comparing the data of the profile with a corresponding data of a chosen profile;
generating a set of possible links based on the set of predetermined association factors between the profile and the chosen profile;
generating a set of possible links based on the set of predetermined associated factors between the profile and an existing data in the database;
generating a degree of separation factor based on a set of connections between the profile and the chosen profile;
eliminating a particular possible link based on a response of a creator of the profile; and
highlighting the particular possible link based on the response of the creator of the profile.

11. The method of claim 1 further comprising:
providing a lead based on the data associated with a particular profile;
generating a link to a corresponding profile based on the lead; and
generating the lead and other leads based on the particular search.

12. The method of claim 1 further comprising:
maintaining an audit record of a set of changes made by a particular user,
wherein the set of changes made by the particular user pertains to at least one of an edit, an entry, a deletion, an uploaded material, privacy options and security options;
automatically saving the set of changes in the audit record; and
generating the audit record when requested by an authorized auditing personnel.

13. The method of claim 1 further comprising:
displaying at least a portion of a particular profile in response to a search performed by a new user;
determining a relevance between the particular profile and the search based on a relevance algorithm,
wherein the relevance algorithm is based on at least one of a similarity of name, a similarity of characteristic, a similarity of crime type, a known gang, a known criminal propensity, a similarity of geographical location, a similarity of background, a similar criminal history, a similar motive, a number and frequency of recurring keywords, a number of visits to a particular physical location, a frequency of visits to a particular physical location, a number of visits to a particular cyber location and a frequency of visits to the particular cyber location;
authenticating the new user to access a larger view of the particular profile based on a role based access control; and
authenticating the new user to update the particular profile based on the role based access control.

14. The method of claim 13 further comprising:
automatically matching the profile with a similar profile based on the predetermined association factors and a data associated with the similar profile; and
graphically representing a set of possible links between the profile and the similar profile.

15. The method of claim 14 further comprising:
when no profile is available, retrieving a relevant set of data in response to the search;
displaying the relevant set of data based on the relevance algorithm; and
permitting the new user to create a new profile for the relevant set of data.

16. The method of claim 1 further comprising:
determining a set of security controls to access the profile associated with the record;
authenticating a user to perform a task on the profile based on a role based access control,
wherein the task is at least one of an input of a new data to the profile, a creation of the profile, a reading of the profile and a deletion of a part of the profile;
performing a metaheuristic analysis of a new information against an existing data in the database;
determining an accuracy of an update of the profile based on a set of accuracy factors,
wherein the set of accuracy factors is at least one of a consistency of data, a conflicting data, prior matching patterns of data;
automatically updating the new data on the profile based on a role based access control; and
generating an alert when the profile is updated.

17. The method of claim 16 wherein the role based access control is at least one of a system-controlled minimum security criteria and a user-controlled minimum security criteria.

18. The method of claim 1 further comprising:
broadcasting an update to a given profile through at least one of an update page associated with an account of a particular user, a compilation cyber communication, a text alert, and a cyber alert;
tagging the update of the given profile with a source of the update through a tagging means,
wherein the tagging means is at least one of a color-coded tag, a user-coded tag, a comment box;
compiling a set of updates into a statistical review to account for an accuracy of a user's individual historical activity; and
graphically representing the statistical review associated with the user.

19. The method of claim 1 further comprising:
linking a set of other profiles to an individual profile,
wherein an individual profile is at least one of an investigation, a gang, a location, an event and a group of individuals;
determining a set of qualifying criteria to link a qualifying profile to the individual profile;
matching the qualifying profile to the individual profile based on the qualifying criteria and the predetermined association factors;
consolidating the set of information of all qualifying profiles to create a group data;
graphically clustering the group data; and
generating a set of connections between the qualifying profiles based on the predetermined association factors.

20. The method of claim 1 further comprising:
verifying that only one profile exists for a POI; and
automatically notifying a user when the profile already exists for the POI.

21. The method of claim 1 further comprising:
uploading a data associated with a POI to the profile,
wherein the data is at least one of a picture, a background, a CV, a criminal record, a warrant, a conviction, a network of known and possible friends, a crime type, a criminal history, a set of cyber names, a set of cyber addresses, a set of telephony addresses, a set of known locations, a set of electronic and cyber communication data obtained legally;
graphically displaying related profiles by clustering the data of the profile with other profiles; and
modifying a graphical display based on a response of a creator of the profile.

22. The method of claim 1 wherein the data is acquired from at least one of a lawfully-acquired data from a lawful database, a lawful data interception, a lawful interrogation, a lawful police record, general public information, a media record, an information obtained from a website, information associated with an IP address, a phone record, a private record, a public record and a police record.

24. A method comprising:
evaluating a profile associated with a record against at least one other profile associated with an other record;
determining a degree of similarity between the profile and the other profile based on a set of predetermined association factors;
automatically creating a connection with the second profile when the degree of similarity is greater than a predetermined threshold value;
analyzing a set of connections between the profile and the other profile; and
graphically displaying the set of connections between the profile and the other profile.

25. The method of claim 24 wherein the record pertains to at least one of a person of interest (POI), a criminal investigation, an event, a group of individuals, a gang, a phone number, a cyber address, a physical address, a website, a phone record and a warrant

26. The method of claim 25 wherein the other is selected through at least one of a direct selection by a user and a result of a query entered by the user.

27. The method of claim 26 wherein the query entered by the user is at least one of a query based on name, a query based on the event, a query based on the gang, a query based on a geographical location, a query based on a background, a query based on a biographical information, a query based on a history, a query based on a criminal record, a query based on a set of current events, a query based on recent updates, a query based on a type of weapon, a query based on a particular gang, a query based on a type of crime, a query based on a type of motive and a query based on a cyber activity between a POI and a set of other POIs, a pattern or frequency of communication activity, a set of phone numbers, a cyber name, a cyber address, and a device address, a VOIP address, a web forum login, a website login, a chat alias, a social network login.

28. The method of claim 27 further comprising:
graphically mapping a connection between the profile and other profiles based on a set of graphic-mapping options,
wherein the set of graphic-mapping options is at least one of a default graphic-mapping option, a user-defined graphic-mapping option, a timeline of activity, a degree of separation between the profile and other profiles, a geographical representation of a set of profiles, a communication link between the profile and other profiles, a historical representation of a profile, a law enforcement timeline of a profile, common records of interest in the profile with the other profile and a user-defined matching factor between the profile and the other profile.

29. The method of claim 28 further comprising:
generating a graphical connection between the set of profiles based on a particular query entered by the user;
modifying the graphical connection based on a response of the user;
eliminating a particular graphical connection based on the response of the user; and
highlighting the particular graphical connection based on the response of the user.

30. The method of claim 29 further comprising:
identifying a shortest connection between the profile and the other profile;
identifying a shortest connection between a POI and an other POI;
when at least two equal shortest connections are identified between the profile and the other profile assigning a weight to a most relevant connection,
wherein the weight is determined through at least one of a user selected criteria, a system criteria and the degree of similarity between the profile and the other profile;
when at least two equal shortest connections are identified between the POI and the other POI assigning a weight to a most relevant connection,
wherein the weight is determined through at least one of a user selected criteria, a system criteria and the degree of similarity between the POI and the other POI;
designating the connection with a higher weight as the shortest connection; and
graphically highlighting the shortest connection.

31. A system comprising a processor communicatively coupled with a volatile memory and a non-volatile storage further comprising:
a profile to store a data associated with a record,
wherein the record pertains to at least one of a person of interest (POI), a criminal investigation, an event, a group of individuals, a gang, a phone number, a cyber name, a cyber address, address, a physical address, a device address, a web host, a web site login, a web forum login, a chat alias, a VOIP address, a phone record and a warrant;
a database to house the profile and other profiles;
a graphical user interface (GUI) to display the data; and
an analysis module,
to synthesize the data associated with the record and a set of other records,
to organize the data associated with the record and the set of other records,
to determine a connection between the profile and the set of other profiles based on a set of predetermined association factors;
to filter the data when a query is entered;
to graphically cluster the data associated with the profile; and
to graphically link the data of the profile with another data.

32. The system of claim 31 wherein the set of predetermined association factors is based on at least one of a geographical commonality, a number of common terms, a number of common suspects, a physical commonality, a number of recurring names, a type of crime, a type of event, a type of cyber address, a type of cyber activity, a number of common aliases, a similar type of website, a similar type of event, a number of known suspects, a common crime scheme, a common Law enforcement agent (LEA), a number of common LEAs, a number of common words, a number of common names, a number of common events, a number of common keywords, a common background between a POI and an other POI, a keyword, a common criminal history between two POIs, at least one common friend between two POIs, a membership in a particular gang, a number of mutual friends between two POIs, a number of similar interests between two POIs, a commonality in victims between two POIs, the common crime scheme between two POIs, known information about the POI to the other POI, a known interaction to the other POI, a number of visits by the POI to a particular physical location, a frequency of visits by the POI to the particular physical location, a number of visits by the POI to a particular cyber location, a frequency of visits by the POI to the particular cyber location, a number of communication attempts between the POI and the other POI and a frequency of communication attempts between the POI and the other POI, a use of specific communication devices, an information about a means and methods of communication and an information on a pattern of communication.
